(19) United States
(12) Patent Application Publication
(10) Pub. No.: US 2025/0364813 A1
(43) Pub. Date: Nov. 27, 2025

(54) OPTIMIZATION OF PARALLEL DC-DC EFFICIENCY ON A BATTERY ELECTRIC MACHINE

(71) Applicant: Caterpillar Inc., Peoria, IL (US)

(72) Inventors: Matthew Lawrence Hendrickson, Dunlap, IL (US); Bradley Scott Bailey, Edwards, IL (US); Rodney L. Menold, Hanna City, IL (US)

(73) Assignee: Caterpillar Inc., Peoria, IL (US)

(21) Appl. No.: 18/671,029

(22) Filed: May 22, 2024

(51) Int. Cl. H02J 3/46; H02M 1/00

(52) U.S. Cl. CPC H02J 3/46; H02M 1/0067

(57) ABSTRACT

At least one aspect of the present disclosure is directed to a method of optimizing parallel DC-DC efficiency. The method includes determining, by one or more processors of a machine, a power demand of the machine according to a load. The method includes identifying, by the one or more processors, efficiency metrics of the machine when operated with a plurality of combinations of power converters, each combination corresponding to a respective power output which combines to the power demand. The method includes selecting, by the one or more processors, a combination of power converters from the plurality of combinations, according to an efficiency metric of the combination satisfying one or more selection criterion. The method includes operating, by the one or more processors, the machine according to the selected combination of power converters, to produce power for the load according to the power demand.

### TECHNICAL FIELD

The present implementations relate generally to optimizing DC-DC converters, and more particularly systems and method to optimize DC-DC converters on a battery electric machine.

### BACKGROUND

The present disclosure optimizing DC-DC converters, and more particularly to optimizing DC-DC converts on a battery electric machine. In some implementations, DC/DC converts may enable efficient power management, voltage regulation, and energy conversion in various machinery. Such systems for DC-DC converters may include a controller to switch the DC-DC converts on or off based on a load of the machine.

For example, U.S. Patent Application No. 2015/357815 describes a system and method for reconfigurable multiple-output power delivery systems including multiple power converters communicably coupled to a switching assembly and the switching assembly communicably coupled to a control apparatus. The control apparatus receives power states of multiple loads from computing system. The control apparatus transmits control signals to the switching assembly to configure coupling of loads to the multiple power converters.

### SUMMARY

A first aspect provided herein relate to a method of optimizing parallel DC-DC efficiency. The method includes determining, by one or more processors of a machine, a power demand of the machine according to a load. The method includes identifying, by the one or more processors, efficiency metrics of the machine when operated with a plurality of combinations of power converters, each combination corresponding to a respective power output which combines to the power demand. The method includes selecting, by the one or more processors, a combination of power converters from the plurality of combinations, according to an efficiency metric of the combination satisfying one or more selection criterion. The method includes operating, by the one or more processors, the machine according to the selected combination of power converters, to produce power for the load according to the power demand.

A second aspect provided herein relate to a machine including a plurality of power converters, a battery bus, energy transfer box, and one or more processors configured to determine a power demand of the machine according to a load. The one or more processors can identify efficiency metrics of the machine when operated with a plurality of combinations of power converters, each combination corresponding to a respective power output which combines to the power demand. The one or more processors can select a combination of power converters from the plurality of combinations, according to an efficiency metric of the combination satisfying one or more selection criterion. The one or more processors can operate the machine according to the selected combination of power converters, to produce power for the load according to the power demand.

A third aspect provided herein relate to a powertrain controller of a machine. The power controller includes one or more processors configured to determine a power demand of the machine according to a load. The one or more processors can identify efficiency metrics of the machine when operated with a plurality of combinations of power converters, each combination corresponding to a respective power output which combines to the power demand. The one or more processors can select a combination of power converters from the plurality of combinations, according to an efficiency metric of the combination satisfying one or more selection criterion. The one or more processors can operate the machine according to the selected combination of power converters, to produce power for the load according to the power demand.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system to optimize parallel DC/DC efficiency, in accordance with present implementations.

FIG. 2 is a block diagram of the machine to optimize parallel DC/DC efficiency, in accordance with present implementations.

FIG. 3 is an example of an efficiency map of a machine operating at 200 kW, in accordance with present implementations.

FIG. 4 is an example of the efficiency map of the machine at 400 kW, in accordance with present implementations.

FIG. 5 is a flowchart showing a method to optimize parallel DC/DC efficiency, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement optimizing parallel DC/DC efficiency to optimize the machine at low to medium power loads. Power converters typically vary in power demands based on the load of the machine. To calculate the power demand, the machine leverages the current load, or a predicted load based on the worksite. Using DC/DC converters, the power converters may support or provide energy to match the power demand. However, inefficient use and a lack of DC/DC converts result in a failure to support the transient response of the machine. According to the systems and methods described herein, the machine can calculate and switch on or off the number of DC/DC converters in real time to provide an efficient response at the machine.

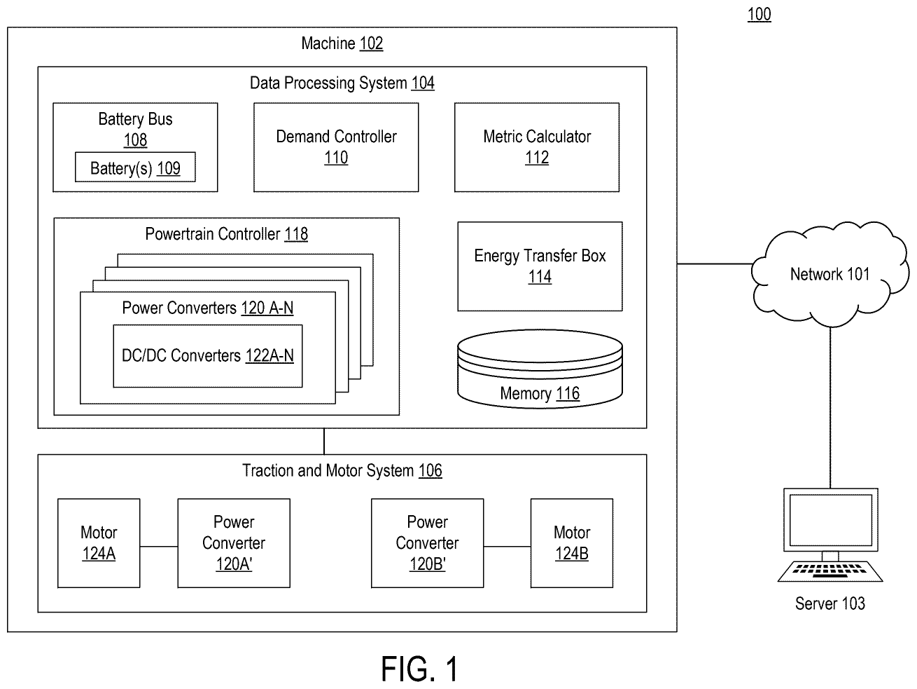

FIG. 1 is a block diagram of a system 100 for optimizing parallel DC/DC efficiency. The system 100 may include at least one machine 102 and at least one server 103. The machine 102 may be present in various environments or systems. For example, the machine 102 may be present within a worksite, an operating location, warehouses for utilizing parallel DC/DC converters to complete tasks and projects associated with the worksite or operation location. The server 103 may be a computing device or control center to monitor the efficiency of the machine 102. The above-mentioned components may be connected to each other through a network 101. The examples of the network 101 may include, but are not limited to, cellular (e.g., 3G, 4G, LTE, 5G, etc.) network, private or public local area network (LAN), wireless-LAN (WLAN), metropolitan area network (MAN), wide area network (WAN), and so forth, which may be used for communicating (e.g., via the Internet) with various endpoints. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The machine 102 can be at least one of charging machine, heavy equipment, electric machine, or heavy machine. The machines 102 can be designed to fulfill tasks corresponding to the operation location at the worksite. For example, at an excavation site, the machine 102 can include bulldozers, excavators, or drill rigs, among others. Each machine 102 can include a transmission system, an engine system, a battery system, a safety system, a communications system, or a hydraulic system, among others. The machines 102 can use the communication system to transmit data and receive data or instructions to and from a control center at the worksite. The system and methods described herein may improve the efficiency of the machine 102 by using a powertrain controller to select a combination of power converters for the machine 102. The machine 102 can include at least one data processing system 104 and at least one traction and motor system 106.

The data processing system 104 may include one or more processors to perform the various steps recited herein. For example, the one or more processors of the data processing system 104 may determine a power demand of the machine 102 according to a load. In another example, the one or more processors of the data processing system 104 may identify efficiency metrics of the machine 102 when operated with a plurality of combinations of power converters. In yet another example, the one or more processors may select a combination of power converters for the machine 102. In this manner, the data processing system 104 may monitor, control, or otherwise execute a combination of converters for the machine 102. The data processing system 104 may include at least one battery bus 108, demand controller 110, metric calculator, energy transfer box 114, memory 116, and a powertrain controller 118.

The battery bus 108 may be a centralized electrical distribution system that provides power to the various components of the machine 102 by using electrical energy stored within one or more batteries 109 (e.g., of the battery bus 108). The one or more batteries 109 may be lithium-ion, lead-acid, or the like. The one or more batteries 109 may be connected to a central bus or electrical distribution network within the machine 102. The battery bus 108 may transmit, send, provide, or otherwise distribute power (electrical energy) to the various components (e.g., demand controller 110, metric calculator 112, Energy transfer box 114, memory 116, powertrain controller 118) of the data processing system 104 and the machine 102 (e.g., traction and motor system 106). For example, the battery bus 108 may transmit electrical energy to the powertrain controller 118. In some embodiments, the battery bus 108 may include DC/DC converters or inverters to regulate voltage levels and DC power from the batteries to the appropriate voltage and frequency required by the components of the machine 102 or the data processing system 104.

The demand controller 102 may detect, monitor, or otherwise identify changes in the load of the machine 102. For example, the machine 102 may be subjected to heavy rain at the worksite. The demand controller 110 may detect the environmental load. Therefore, the load may negatively impact the performance, durability, and/or other operations of the machine 102. In another example, the machine 102 may carry coal, dirt, other machines, etc., increasing the mechanical load of the machine 102. Again, the mechanical load may negatively impact the performance, durability, and/or other operations of the machine 102. To mitigate the negative effects of the loads, the data processing system 104 may use a plurality of combinations for the DC/DC converters that switch based on the load of the machine.

The metric calculator 112 may calculate, generate, or otherwise determine metrics for the machine 102. In some embodiments, the data processing system 102 may transmit the metrics from the metric calculator 112 to a server 103, control center, or external computing devices 103. The metrics may include at least one of power consumption, operating hours, load capacity, energy efficiency, utilization rate, down time, maintenance, environmental impacts, productivity, among others. By calculating and generating, then transmitting, the metrics to the server 103 or a display on the machine 102, operators may gain valuable insights about the performance, efficiency, and reliability of the machines 102. Furthermore, the other components of the data processing system 104 may use the metrics to implement parallel DC/DC optimization.

The energy transfer box 114 may transfer, direct, or transmit electrical energy from the power converters to various auxiliary components or systems of the machine 102. The auxiliary system(s) may include (but are not limited to) a cooling system, a hydraulic system, electrical system, exhaust treatment system, and the like. Each of the auxiliary components and system may use electrical energy to function. For example, energy transfer box 114 may transmit energy from power converters 120A-N (generally referred to as “power converters 120” or as a “power converter 120”) to the hydraulic system of the machine 102 to lift, dig, or steer the machine 102 at the worksite. The energy transfer box 114 may regulate an amount of electrical energy for the auxiliary components and systems based on metrics from the metric calculator 112 and the load from the demand controller 110.

The memory 116 may be or include any type or form of data storage device, including tangible, non-transient volatile memory and/or non-volatile memory. The memory 116 may include one or more hardware memory devices to store binary data, digital data, or the like. The memory 116 may include one or more electrical components, electronic components, programmable electronic components, reprogrammable electronic components, integrated circuits, semiconductor devices, flip flops, arithmetic units, or the like. The memory 116 can include at least one of a non-volatile memory device, a solid-state memory device, a flash memory device, and a NAND memory device. The memory 116 may include one or more addressable memory regions disposed on one or more physical memory arrays. A physical memory array can include a NAND gate array disposed on, for example, at least one of a particular semiconductor device, integrated circuit device, or printed circuit board device.

The memory 116 may store, house, or maintain electrical energy patterns of the machine 102. For example, the machine 102 may execute a plurality of tasks and projects associated with lifting. The data processing system 102 may store the electrical energy patterns, during the execution of the tasks, within the memory 116. The memory 116 may store combinations of the power converters 120 for use at a future time period when a similar load occurs at the demand controller 110. For example, at a first time period, the demand controller 110 may detect the load at the machine 102. The demand controller 110 may store the load in the memory 116 and the powertrain controller 118 may store a selection combination of power converters 120 in the memory 116. At the future time period, the demand controller 110 may detect a load which is similar/matches the previously detected load 110. The powertrain controller 118 may retrieve the previous combination of power converters 120 from the memory 116 and select the retrieved combination of power converters 120.

The powertrain controller 118 may control, trigger, or otherwise monitor the interactions between each component of the data processing system 104. The powertrain controller 118 may trigger the various components of the data processing system 104. For example, the powertrain controller 118 may trigger the demand controller 110 to determine a power demand of the machine 102. In another example, the powertrain controller 118 may trigger the metric calculator 112 to calculate metrics for the machine. The powertrain controller 118 may select, determine, or otherwise identify a combination for the power converters 120 by analyzing the needs of the machine 102. The needs of the machine 102 may vary based on the load of the machine 102. In this manner, the powertrain controller 118 may continuously select combinations of power converters 120 to optimize the performance of the machine 102, the longevity of the power converters 120, and/or the durability of the machine 102/power converters 120. For example, the load of the machine 102 may increase as the machine 102 carries coal throughout the worksite. Rather than using a single power converter 120 to handle the increased load, the powertrain controller 118 may trigger two power converters (e.g., power converter 120A and power converter 120B) to each handle half of the increased load to improve the durability of and reduce strain on a singular power converter 120.

The power converters 120 may be electronic devices, hardware, or components to convert, transform, or otherwise supply electric energy from one form to another. The power converters 120 may be oriented parallel to one another within the machine 102. For example, the first power converter 120A and a second power converter 120B may be in parallel. The power converters 120 may include or utilize various semiconductor devices, such as diodes, transistors, thyristors, and the like, coupled with control circuits, filters, and protection mechanisms to achieve or obtain efficient and reliable energy conversion. The power converter 120 may allow for the utilization of electrical energy and facilitation of renewable energy sources, energy storage systems, and electrical energy machines 102. The power converter 120 may be an AC/DC converter (rectifier) to convert AC from the battery bus 108 into DC. The power converter 120 may be a DC/AC converter (inverter) to convert DC from the battery bus 108 into AC. The power converter 120 may be or include a DC/DC converter 122 (e.g., to step up/step down voltage/power/current for a particular load).

The power converters 120 may supply the electric energy of the rectifier or the inverter by using a plurality of parallel DC/DC converters 122A-N (generally referred to as “DC/DC converters 122” or as a “DC/DC converter 122”). The DC/DC converters 122 may be or include at least one of a buck converter, boost converter, a buck-boost converter, a flyback converter, or a full-bridge converter. The DC/DC converters 122 may utilize semiconductor devices such as diodes, transistors, and integrated circuits (ICs) to regulate voltage and control power flow. By using signals from them powertrain controller 118, the DC/DC converters 122 may enable efficient energy conversion and power distribution without sacrificing the performance or longevity of the machine 102.

The traction and motor system 106 of the machine 102 may include various components to responsible for providing power and control to propel, move or otherwise force the machine 102 to perform the intended function requested by an operator. The traction and motor system 106 may include power converters 120A-N′ (generally referred to as “power converters 120′” or as a “power converter 120′”) that function similar to the power converters 120 described above. The power converters 120′ may be inverters to convert the DC from the DC/DC converters 122 to AC for the motor 124. The motor 124 may be an electric motor to convert electrical energy into mechanical energy to drive and control the machine 102. For example, the motor 124 may be electrically coupled to brakes of the machine 102 to force the machine 102 to stop upon reception of AC from the power converter 120A′. In another example, the motor 124 may be electrically coupled to the wheels of the machine 102. Upon reception of AC from the power converter 120A, the motor 124 may trigger the wheels to rotate.

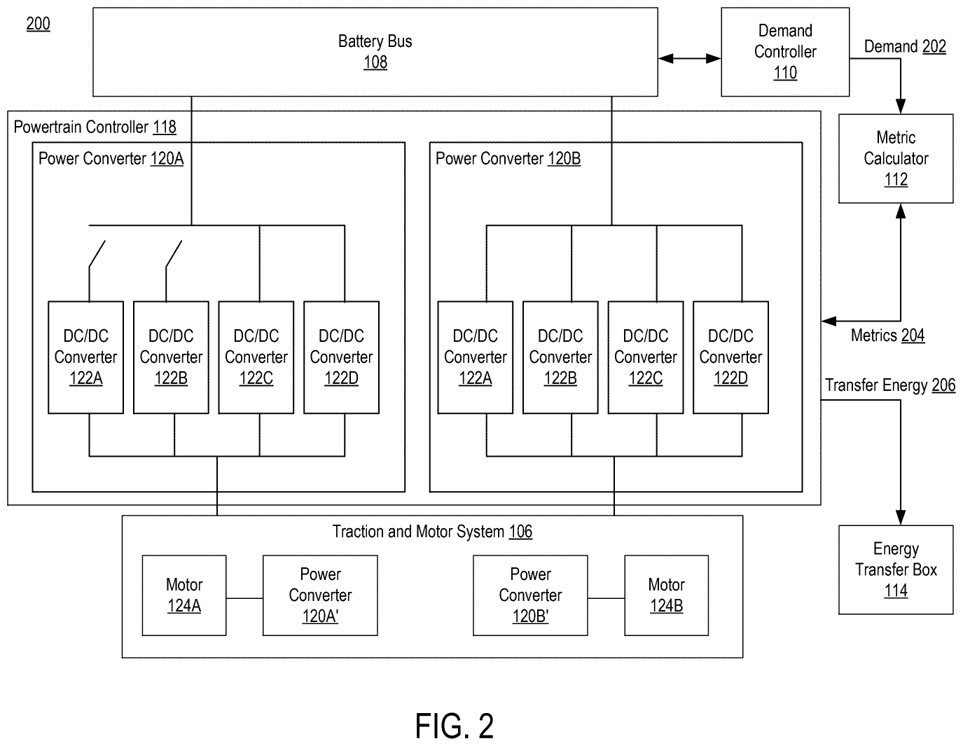

FIG. 2 is a block diagram 200 of the machine 102 to optimize parallel DC/DC efficiency. The battery bus 108 may transmit, provide, or supply electrical energy to the powertrain controller 118. For example, the battery bus 108 may transmit, provide, supply, or otherwise transfer a continuous stream of electrical energy to the powertrain controller 118 while the machine 102 is in operation. For example, the battery bus 108 may transfer electrical energy from the one or more batteries 109 to the powertrain controller 118 while the machine 108 is moving toward a worksite. The demand controller 110 may vary the amount of electrical energy the batteries 109 supply to the powertrain controller 118 based on command(s) by the operator. For example, the operator may place the machine 102 in park after the machine 102 moves up a hill at the worksite. In response, the batteries 109 may provide significantly less electrical energy to the powertrain controller 118.

The demand controller 110 may calculate, generate or otherwise determine a power demand 202 for the machine 102. The power demand 202 may correspond with a requested amount of power from the batteries 109. Using the load of the machine, the demand controller 110 may calculate, generate or otherwise determine a power demand 202 for the machine 102. In some embodiments, the load may be at least one of the mechanical load, an electric load, a thermal load, and the environmental load. As the load increases, the power demand 202 of the machine increases. For example, heavy amounts of mud at the worksite, may increase the load corresponding to the environmental load causing the machine to use more electrical energy to move toward an operation location at the worksite. The demand controller 110 may detect the increased load and increase the power demand 202 for the machine 102. Conversely, as the load decreases, the power demand 202 may decrease. For example, the machine 202 may dump the contents of the bed of the machine 102 at an operation location. The demand controller 110 may detect the decreased load (i.e., reduction of a weight of the machine 102) and reduce the power demand 202 of the machine 103.

In some embodiments, the demand controller 110 may detect the changes in load based on data from one or more sensors of the machine 102. For example, the sensors may be configured to supply various sensor measurement(s) to the demand controller 110 which indicate or otherwise relate to the load. In various embodiments, the sensors may read, measure, sense, or otherwise detect at least one of temperature, pressure, speed, position, load, vibration, level, proximity, among others. The sensors may transmit an indication of the changes in load to the demand controller 110. For example, as the speed increases, the speed sensor may communicate data indicative of the increased speed (which in turn indicates an increase in the mechanical load) and transmit the data to the demand controller 110 to increase the power demand 202. In another example, the position sensor may detect that the machine 102 is on a steep incline. Therefore, the position sensor may provide data indicative of the grade of the incline to the demand controller 110, and the demand controller 110 to increase the power demand 202 (e.g., based on the increase in mechanical load sensed by the position sensor).

The metric calculator 112 may determine, indicate, or identify efficiency metrics 204 of the machine 102. The efficiency metrics 204 may indicate the effectiveness and productivity of systems or operations of the machine 102. For example, the efficiency metric 204 may indicate energy efficiency as a ratio. The ratio can be between the energy output by the machine 102 and the energy provided by the battery bus 108. Therefore, the efficiency metrics 204 may identify how effectively the energy resources are utilized by the machine 102. The efficiency metrics 204 may include at least one of the load of the machine 102, a battery state, a state of the machine 102, and a traction bus on the machine 102. The battery state may indicate a state of voltage, a state of health, or a state of charge of the battery.

The metric calculator 112 may determine, indicate, or identify efficiency metrics 204 of the machine 102 when operated by combinations of power converters 120. The powertrain controller 118 may trigger operation of various combination(s) of the power converters 120. The metrics calculator 112 may be configured to generate or calculate the efficiency metric 204 as the combination(s) of power converter(s) 120 are operated. Within each combination of power converters 120, the power converters 120 may include a combination of DC/DC converters 122 as shown in FIG. 2. For example, a first power converter 120A may include four DC/DC converters 122A-D, where DC/DC converter 122A and DC/DC converter 122B include an open switch. A second power converter 120A may include four DC/DC converters 122A-D, where each DC/DC converter 122 includes a closed switch. The powertrain controller 118 may track, monitor, or otherwise obtain the voltage across each power converter 120 (i.e., input voltage on input side of a combination and output voltage on an output side of the combination). To generate the efficiency metrics 204, the powertrain controller 118 or the metric calculator 112 may use the equation 1) shown below:

$${η}_{eff} = \frac{{V}_{out}}{{V}_{in}} \qquad Eq . 1$$

In some embodiments, the powertrain controller 118 or the metric calculator 112 may transmit, send, or store the efficiency metrics 204 within the memory 116. While in memory 116, the server 103 may extract the efficiency metrics 204 to generate efficiency maps for the machine 102.

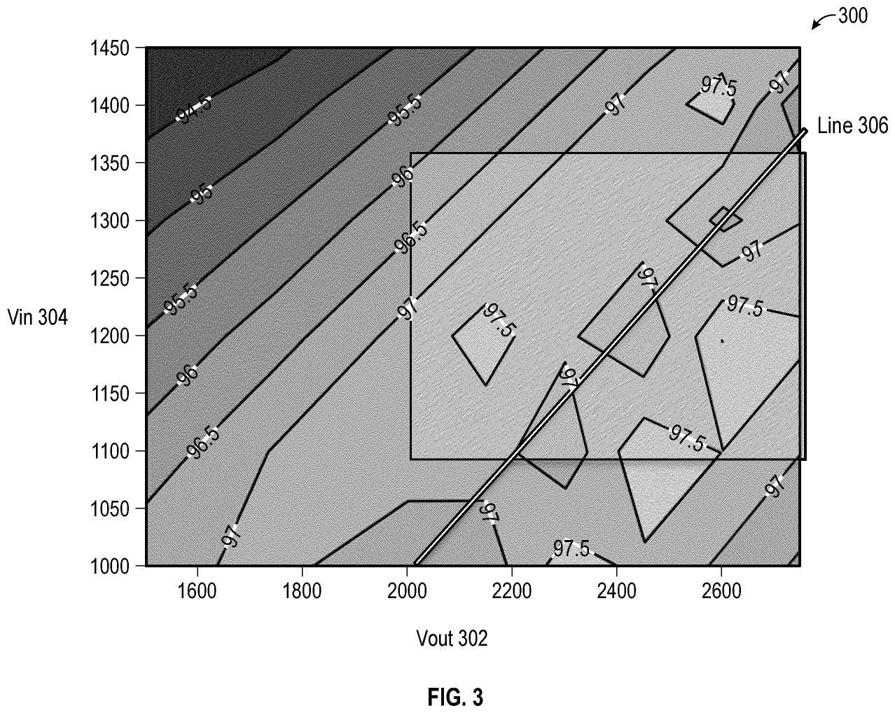

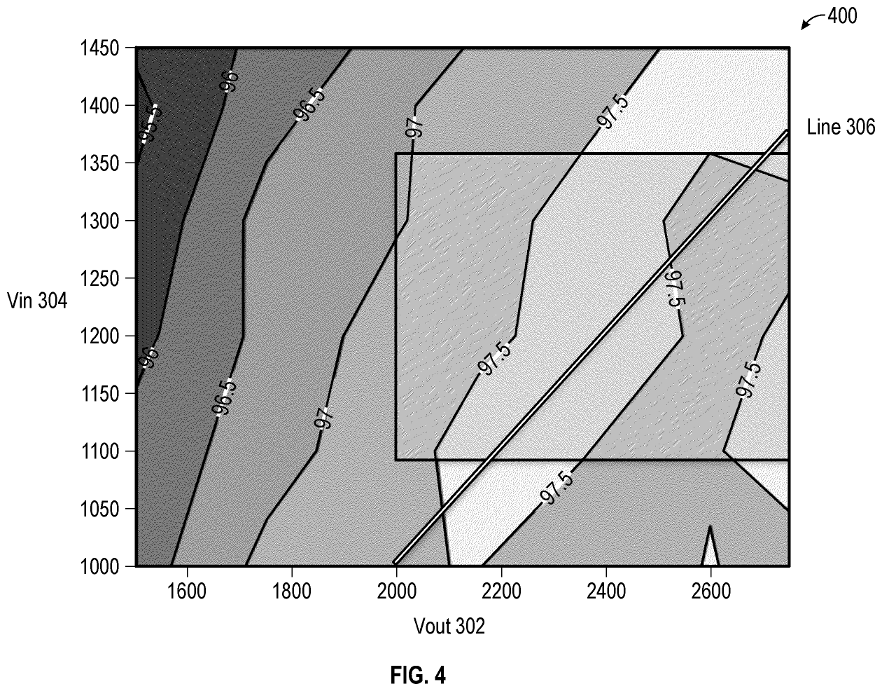

Referring now to FIG. 3 and FIG. 4 depicts an example of an efficiency map 300 and an efficiency map 400 of the machine 102 operating at 200 kW and 400 kW, respectively. The machine 102 operating at 200 kW is used as an example, though it should be understood that various examples of machines 102 can operate at many different powers depending on load and power demand of the machine 102. In FIG. 3 and FIG. 4, Vₒᵤₜ 302 is depicted along the Y-Axis, whereas Vᵢₙ 304 is depicted along the X-Axis. In some embodiments, the server 103 may transmit the efficiency maps to the machine 102 on a display for the operator. For example, the server 103 may transmit an efficiency map of the machine 102 operating at 300 kW to the display of the machine 102. In another example, the server 103 may transmit an efficiency map of the machine 102 operating at 600 kW to the display of the machine 102. In yet another example, the server 103 may transmit an efficiency map of the machine 102 operating at 800 kW to the display of the machine 102. Each efficiency map 300 may include a line of peak efficiency (e.g., line 306 and line 406) where the efficiency metric 204 is the highest at different instances of Vᵢₙ 304. In various embodiments, the server 103 may transmit data corresponding to the efficiency map (e.g., rather than the efficiency map itself) for use by the machine 102.

Referring again to FIG. 1 and FIG. 2, the memory 116 may store, maintain, include, or otherwise access selection criteria (or criterion) for the power demand 202 of the machine. The selection criteria may be a minimum output to the traction and motor system 106 to overcome the power demand 202. For example, the machine 102 may have a power demand 202 of 400 kW, the selection criteria may include a threshold of at least 400 kW. The selection criteria may include a minimum efficiency metric 204 for the power converters 120. For example, the machine 102 may have a power demand 202 of 200 kW and the metric calculator 112 may generate an efficiency metric 204 of 97.0. The selection criteria may include a minimum efficiency metric 204 of at least 97.0 for the machine 102.

In some embodiments, the demand controller 110 may generate or determine the selection criteria based on loads, power demands 202, and combinations of power converters 120 during a previous time period and store the selection criteria in the memory 116. Using the selection criteria, the system 100 may identify the combinations of power converters 120 faster while utilizing less computer resources. In some embodiments, the selection criteria may include a minimum efficiency for each DC/DC converter 122 within the power converters 120. For example, the machine 102 may have a power demand 202 of 200 kW and the metric calculator 112 may generate an efficiency metric 204 of 97.0. The selection criteria may include a minimum efficiency metric 204 of at least 97.0 for the DC/DC converters 122 of the machine 102.

The metric calculator 112 may iterate, traverse, or parse through various efficiency metric(s) 204 for combination(s) of power converters 120 to identify or determine a maximum efficiency metric 204 for the machine 102. For example, the powertrain controller 120 may provide a plurality of efficiency metrics 204 at one power (e.g., 200 kW) as shown in FIG. 3. The powertrain controller 118 may vary each DC/DC converter 122 to vary, change, or adjust the Vᵢₙ 304, to generate an efficiency metric 204 at each instance of Vᵢₙ 304. From each efficiency metric 204 provided by the powertrain controller 120, the metric calculator 112 may identify a max efficiency metric 204 for each power of the power converter 120. For example, the powertrain controller 118 may provide efficiency metrics 204 for power converter 120A while varying each DC/DC converter 122 A-N. The powertrain controller 118 may provide efficiency metrics 204 for power converter 120B while varying each DC/DC converter 122 A-N. The metric calculator 112 may identify the efficiency metrics 204 of power converter 120A by comparing each efficiency metric 204 from power converter 120A and power converter 120B.

The powertrain controller 118 may receive the maximum efficiency metrics 204 for the identified power converter 120 from the metric calculator 112. Response to receiving the maximum efficiency metrics 204 for the identified power converter 120, the powertrain controller 118 may select a combination of power converters 120. To select the combination, the powertrain controller 118 may disconnect/connect one or more power converters 120 from the battery bus 108. For example, to achieve the maximum efficiency metric 204, the powertrain controller 118 may disconnect a first power converter 120A, a second power converter 120B, and a third power converter 120C. Furthermore, the powertrain controller 118 may connect the rest of the power converter 120D-N. In another example, the powertrain controller 118 may connect powertrain converter 120A and disconnect the rest of the power converters 120B-N.

In some embodiments, the powertrain controller 118 may select the combination of DC/DC converters 122 by using the maximum efficiency metrics 204 for the identified power converter 120. For example, the maximum efficiency metric 204 may correspond to three DC/DC converters (i.e., DC/DC converter 122A, DC/DC converter 122B, DC/DC converter 122C) having the switch ON, while one DC/DC converter 122D has the switch OFF. In another example, the maximum efficiency metric 204 may correspond to two DC/DC converters (i.e., DC/DC converter 122A, DC/DC converter 122B) having the switch ON, while two DC/DC converters (i.e., DC/DC converter 122C, DC/DC converter 122D has the switch OFF. The selection of the combinations of DC/DC converters 122 enables the machine 102 to improve efficiency of electrical energy management while the machine 102 is operating within the worksite.

In some embodiments, the demand controller 110 may identify, determine, or access a state of the machine 102. The state of the machine may refer to the current condition, status, or operational state of the machine. The state of the machine may indicate the performance, functionality, health, or readiness of the machine 102 for operations. For example, an operator of the machine 102 may use a gas pedal to move the machine 102. Therefore, the state of the machine 102 may be running. In another example, the machine 102 may be in park, therefore the state of the machine 102 is idle. In some embodiments, the powertrain controller 118 may select the combination of power converters 120 based on the efficiency metric and the state of the machine 102.

In some embodiments, the powertrain controller 118 may transmit, send, or provide transfer energy 206 from the selected combination power converters 120 to the energy transfer box 114. Using the transfer energy 206, the energy transfer box 114 may distribute or provide the transfer energy 206 to the various components of the machine 102. For example, the machine 102 may include a forklift, thus the energy transfer box 114 may provide transfer energy 206 to operate the forklift of the machine 102. For another example, the machine 102 may include deployable stabilizers, thus the energy transfer box 114 may provide transfer energy 206 to operate the stabilizers of the machine 102.

The powertrain controller 118 may operate, control, or otherwise handle the traction and motor system 106 of the machine 102 based on the selected combination of power converters 120. The output power or the transfer energy 206 may be DC from the power converter 120. The energy transfer box 114 may use DC to supply the transfer energy 206 to the various components of the machine 102. However, the traction and motor system 106 may require the output power in the form of AC. Therefore, the power converters 120′ may convert or transform the output power from DC to AC. For example, the combination of power converters 120A-D may provide the power converter 120A′ of the traction and motor system 106 with DC. The power converter 120A′ may covert the DC to AC using one or more DC/AC converters within the power converters 120A′.

The power converters 120′ may provide, supply, and transmit the AC to the motors 124 of the machine 102 to produce power for the load based on the power demand 202. The DC provided by the power converters 120 may match the power demand 202 to satisfy the load, while maintaining the maximum efficiency metric 204. For example, the power demand 202 may require at least 300 kW of power to overcome the load. The selected combination of power converters 120 may provide 310 KW with an efficiency of 97.5. The powertrain controller 118 may provide 310 kW of power, in DC, to the power converters 120A′. The power converters 120A′ may convert the 310 KW of power, in DC to AC, and transmit the 310 KW of power to the motors 124 to overcome the load.

### INDUSTRIAL APPLICABILITY

The disclosed embodiments may be applicable to any power converter system or solution (e.g., machine 102). For example, the disclosed embodiments may be applicable to or applied to a vehicle, such as an automobile, heavy machinery, or any other type of vehicle, a power source for a home, office, or any other residential/industrial setting, or any other power delivery system which may be powered by a battery bus. The disclosed embodiments may be applicable to power converter systems which use or include AC/DC converters, DC/AC converters, or DC/DC converters that struggle to optimize power converter efficiency based on the varying demands of a corresponding vehicle and power sources. The powertrain controller 118 may be provided to optimize power converters 120 within the machine 102. For example, the powertrain controller 118 may select a combination of power converters 120 based on varying factors provided by the demand controller 110, where the demand controller 110 determines such factors according to the load of the heavy machine 102. The powertrain controller 118 may be provided to increase durability of the power converters 120 within the machine 102. For example, the powertrain controller 118 may select a combination based on the durability of each power converter 120 or DC/DC converters 122.

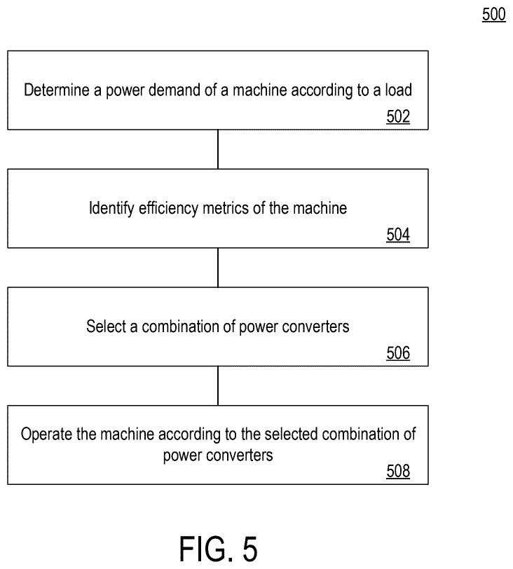

Referring now to FIG. 5, depicted is a flowchart showing an example method 500 for the optimization of parallel DC/DC efficiency on a battery electric machine 102. The method 400 may be performed by, implemented on, or otherwise executed by the components, elements, or hardware described above with reference to FIG. 1 and FIG. 2. For example, the method 400 may be executed by the components of FIG. 1. As a brief overview, at step 502, the demand controller 110 may determine a power demand 202 based on a load of the machine 102. At step 504, the powertrain controller 118 and the metric calculator 112 may identify efficiency metrics 204 of the machine 102. At step 506, the powertrain controller 118 may select a combination of power converters 120. At step 508, the powertrain controller 118 may operate the machine 102 according to the selected combination of power converts 120.

At step 502, the demand controller 110 may determine a power demand 202 based on a load of the machine 102. The demand controller 110 may use one of more sensors to identify the load of the machine by measuring and monitoring the activity of the machine 102. Using the load, the demand controller 110 may determine the power demand 202 to satisfy the load and operate the machine 102 to perform the tasks at the worksite.

At step 504, the powertrain controller 118 or the metric calculator 112 may identify efficiency metrics 204 of the machine 102 when operated with a plurality of combinations of power converters 120. Each combination of power converters may correspond to a respective power output which combines to the power demand. For the respective power output, the metric calculator 112 or the powertrain controller 118 may identify data corresponding to an efficiency map (e.g., map 300, map 400) indicating a plurality of efficiency metrics at different input and output voltages. Each efficiency map may correspond to a different power output (e.g., 200 kW, 400 kW, 600 kW).

At step 506, the powertrain controller 118 may select a combination of power converters 120 using an efficiency metric of the combination of power converters 120 to satisfy one or more selection criterion. The selection criterion may include one or more thresholds to satisfy or overcome the power demand 202 of the machine 102 corresponding to the load. Prior to selecting the combination of power converters 120, the powertrain controller 118 may determining an input voltage and an output voltage, on an input side and an output side of combination. Using the input voltage and the output voltage, the metric calculator 112 may identify one or more efficiency metrics corresponding to one or more respective power outputs. In some embodiments, the powertrain controller 118 may select the combination of power converters 120, based on a count of power converters outputting power at the respective power output, to combine to produce the power demand 202.

At step 508, the powertrain controller 118 may operate the machine 102 according to the selected combination of power converters 120. The powertrain controller 118 may transmit the output power to the traction and motor system 106 to overcome the load while optimizing the plurality of power converters 120 and the plurality of DC/DC converters 122. To overcome the load, the power converters 120′ may provide the motors 124 with the output power from the powertrain controller 118. Upon receiving the output power, the motors 124 may execute to overcome the load. In some embodiments, the powertrain controller 118 may output transfer energy 206 to the energy transfer box 114 to distribute electrical energy to the various components of the machine 102.

What is claimed is:

1. A method, comprising:
determining, by one or more processors of a machine, a power demand of the machine according to a load;
identifying, by the one or more processors, efficiency metrics of the machine when operated with a plurality of combinations of power converters, each combination of power converters corresponding to a respective power output which combines to the power demand;
selecting, by the one or more processors, a combination of power converters from the plurality of combinations, according to an efficiency metric of the combination satisfying one or more selection criterion; and
operating, by the one or more processors, the machine according to the selected combination of power converters, to produce power for the load according to the power demand.

2. The method of claim 1, wherein determining the efficiency metric comprises:
identifying, by the one or more processors, for a first respective power output, data corresponding to a first efficiency map indicating a plurality of first efficiency metrics at different input and output voltages; and
identifying, by the one or more processors, for a second respective power output, data corresponding to a second efficiency map indicating a plurality of second efficiency metrics at different input and output voltages.

3. The method of claim 2, further comprising:
determining, by the one or more processors, input voltage and output voltage, on input side and output side of combination;
identifying, by the one or more processors, a first efficiency metric corresponding to the first respective power output, based on the input voltage and the output voltage; and
identifying, by the one or more processors, a second efficiency metric corresponding to the second respective power output, based on the input voltage and the output voltage.

4. The method of claim 3, further comprises selecting, by the one or more processors, the combination of power converters, based on a count of power converters outputting power at the first respective power output, to combine to produce the power demand, based on the first efficiency metric being greater than the second efficiency metric.

5. The method of claim 1, wherein the plurality of power converters are in parallel with one another and include one or more parallel DC to DC converters.

6. The method of claim 1, further comprising:
determining, by the one or more processors, state of machine; and
selecting, by the one or more processors, the combination according to the efficiency metric and state of the machine.

7. The method of claim 6, wherein the efficiency metric is based on at least one of a load of the machine, a battery state, the state of the machine, and a traction bus on the machine.

8. The method of claim 7, wherein the battery state comprises a state of voltage, a state of health, or a state of charge.

9. The method of claim 6, wherein the state of the machine further comprises one or more operator commands indicative of the load or a predicted load.

10. A machine, comprising:
a plurality of power converters;
one or more processors configured to:
determine a power demand of the machine according to a load;
identify efficiency metrics of the machine when operated with a plurality of combinations of power converters, each combination corresponding to a respective power output which combines to the power demand;
select a combination of power converters from the plurality of combinations, according to an efficiency metric of the combination satisfying one or more selection criterion; and
operate the machine according to the selected combination of power converters, to produce power for the load according to the power demand.

11. The machine of claim 10, wherein, when determining the efficiency metric, the one or more processors are further configured to:
identify for a first respective power output, data corresponding to a first efficiency map indicating a plurality of first efficiency metrics at different input and output voltages; and
identify for a second respective power output, data corresponding to a second efficiency map indicating a plurality of second efficiency metrics at different input and output voltages.

12. The machine of claim 11, the one or more processors are further configured to:
determine input voltage and output voltage, on input side and output side of combination;
identify a first efficiency metric corresponding to the first respective power output, based on the input voltage and the output voltage; and
identify a second efficiency metric corresponding to the second respective power output, based on the input voltage and the output voltage.

13. The machine of claim 12, wherein the one or more processors are further configured to select, the combination of power converters, based on a count of power converters outputting power at the first respective power output, to combine to produce the power demand, based on the first efficiency metric being greater than the second efficiency metric.

14. The machine of claim 10, wherein the plurality of power converters are in parallel with one another and include one or more parallel DC to DC converters.

15. The machine of claim 10, the one or more processors are further configured to:
determine a state of the machine; and
select the combination according to the efficiency metric and the state of the machine.

16. The machine of claim 15, wherein the efficiency metric is based on at least one of a load of the machine, a battery state, the state of the machine, and a traction bus on the machine.

17. The machine of claim 16, wherein the battery state comprises a state of voltage, a state of health, or a state of charge.

18. The machine of claim 15, wherein the state of the machine further comprises one or more operator commands indicative of the load or a predicted load.

19. The machine of claim 11, wherein the one or more processors comprise a powertrain controller.

20. A power controller for a machine, the power controller comprising:
one or more processors configured to:
determine a power demand of the machine according to a load;
identify efficiency metrics of the machine when operated with a plurality of combinations of power converters, each combination corresponding to a respective power output which combines to the power demand;
select a combination of power converters from the plurality of combinations, according to an efficiency metric of the combination satisfying one or more selection criterion; and
operate the machine according to the selected combination of power converters, to produce power for the load according to the power demand.
